(19) United States
(12) Patent Application Publication
(10) Pub. No.: US 2008/0165428 A1
(43) Pub. Date: Jul. 10, 2008

(54) Zoom lens and image capture apparatus

(75) Inventors: Tetsuya Arimoto, Osaka (JP); Yasushi Yamamoto, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/902,723

(22) Filed: Sep. 25, 2007

(30) Foreign Application Priority Data
Oct. 2, 2006 (JP) 2006-270764

(51) Int. Cl. G02B 15/14

(52) U.S. Cl. 359/687

(57) ABSTRACT

There is provided a zoom lens including, in an order from an object side: a first lens group having positive refractive power; a second lens group having negative refractive power; a third lens group having positive refractive power; and a fourth lens group having positive refractive power. During zooming from a wide-angle end to a telephoto end, the first lens group, the third lens group, and the fourth lens group move toward an object side such that a distance between the first lens group and the second lens group increases, a distance between the second lens group and the third lens group decreases, and a distance between the third lens group and the fourth lens group decreases, and the zoom lens satisfies the following conditional formulae (1) and (2):

1.8<f3/fw<5, and (1)

−2.5<2×D3/f2<−1.5. (2)

### CROSS REFERENCES TO RELATED APPLICATIONS

The present document contains subject matter related to Japanese Patent Application JP 2006-270764 filed in the Japanese Patent Office on Oct. 2, 2006, the entire contents of which being incorporated herein by reference.

### BACKGROUND OF THE INVENTION

1. Field of the Invention

The present invention relates to a zoom lens and an image capture apparatus, and particularly to a zoom lens which is suitable for an interchangeable lens releasably attached to a silver-salt-film single-lens reflex camera or a digital single-lens reflex camera, being high performance and ensuring sufficient back focus, and to an image capture apparatus using such a zoom lens.

2. Description of Related Art

In recent years, as the number of pixels in photoelectric conversion devices increases, there are demands for higher-performance image-taking optical systems, and moreover, for zoom lenses with small F-numbers covering a wide-angle range. In addition, in interchangeable lenses, there is a restriction that sufficient back focus be ensured, and this leads to difficulties in, e.g., correcting distortion associated with their wider-angle implementations.

In a related art, e.g., Japanese Patent Application Publication No. JP 2004-198529 (Patent Document 1) proposes a zoom lens having an F-number at a wide-angle end of 2.8, with a six-group zooming configuration including, in the following order from an object side, a negative first lens group, a positive second lens group, a negative third lens group, a positive fourth lens group, a negative fifth lens group, and a positive sixth lens group.

In addition, Japanese Patent Application Publication No. JP 2004-101739 (Patent Document 2) proposes a zoom lens whose F-number is in the order of 2.9 in the entire zooming range, with a four-group configuration, in which a positive first lens group, a negative second lens group, a positive third lens group, and a positive fourth lens group are arranged in an order from the object side, and all the lens groups move independently of one another during power variation.

### SUMMARY OF THE INVENTION

However, the zoom lens disclosed in Patent Document 1 requires the six-group configuration, which in turn makes a zoom barrel construction complicated, whereas the zoom lens disclosed in Patent Document 2 has an angle of view at the wide-angle end of approximately 75 degrees, which is insufficient.

In view of the above and other issues, it is desirable to provide a zoom lens which is suitable for an interchangeable lens releasably attached to a silver-salt-film single-lens reflex camera or a digital single-lens reflex lens, being high performance and compact and ensuring sufficient back focus, and an image capture apparatus using such a zoom lens.

According to one embodiment of the present invention, there is provided a zoom lens which includes, in an order from an object side, a first lens group having positive refractive power; a second lens group having negative refractive power; a third lens group having positive refractive power; and a fourth lens group having positive refractive power. During power variation from a wide-angle end to a telephoto end, the first lens group, the third lens group, and the fourth lens group move toward the object side such that a distance between the first lens group and the second lens group increases, a distance between the second lens group and the third lens group decreases, and a distance between the third lens group and the fourth lens group decreases. The zoom lens satisfies the following conditional formulae (1) and (2):

1.8<f3/fw<5, and (1)

−2.5<2×D3/f2<−1.5, (2)

where:
f3 represents a composite focal length of the third lens group,
fw represents a composite focal length of the total system at the wide-angle end,
D3 represents a height from an optical axis of axial rays passing through a surface closest to the object side of the third lens group at the telephoto end, and
f2 represents a composite focal length of the second lens group.

Furthermore, according to another embodiment of the present invention, there is provided an image capture apparatus which includes a zoom lens and an image sensor for converting an optical image formed by the zoom lens into an electrical signal. The zoom lens includes, in an order from an object side, a first lens group having positive refractive power; a second lens group having negative refractive power; a third lens group having positive refractive power; and a fourth lens group having positive refractive power. During power variation from a wide-angle end to a telephoto end, the first lens group, the third lens group, and the fourth lens group move toward the object side such that a distance between the first lens group and the second lens group increases, a distance between the second lens group and the third lens group decreases, and a distance between the third lens group and the fourth lens group decreases. The zoom lens satisfies the following conditional formulae (1) and (2):

1.8<f3/fw<5, and (1)

−2.5<2×D3/f2<−1.5, (2)

where
f3 represents a composite focal length of the third lens group,
fw represents a composite focal length of the total system at the wide-angle end,
D3 represents a height from an optical axis of axial rays passing through a surface closest to the object side of the third lens group at the telephoto end, and
f2 represents a composite focal length of the second lens group.

These and other features and aspects of the invention are set forth in detail below with reference to the accompanying drawings in the following detailed description of the embodiments.

### BRIEF DESCRIPTION OF THE DRAWINGS

FIG. 1 is a diagram showing a lens construction of a zoom lens according to a first embodiment of the present invention;

FIG. 2 is a graph showing, along with FIGS. 3 and 4, aberrations of a first numerical embodiment obtained by applying specific numerical values to the zoom lens according to the first embodiment, FIG. 2 showing a spherical aberration, an astigmatism, and a distortion measured at a wide-angle end;

FIG. 3 is a graph showing a spherical aberration, an astigmatism, and a distortion measured at an intermediate focal length;

FIG. 4 is a graph showing a spherical aberration, an astigmatism, and a distortion measured at a telephoto end;

FIG. 5 is a diagram showing a lens construction of a zoom lens according to a second embodiment of the present invention;

FIG. 6 is a graph showing, along with FIGS. 7 and 8, aberrations of a second numerical embodiment obtained by applying specific numerical values to the zoom lens according to the second embodiment, FIG. 6 showing a spherical aberration, an astigmatism, and a distortion measured at a wide-angle end;

FIG. 7 is a graph showing a spherical aberration, an astigmatism, and a distortion measured at an intermediate focal length;

FIG. 8 is a graph showing a spherical aberration, an astigmatism, and a distortion measured at a telephoto end;

FIG. 9 is a diagram showing a lens construction of a zoom lens according to a third embodiment of the present invention;

FIG. 10 is a graph showing, along with FIGS. 11 and 12, aberrations of a third numerical embodiment obtained by applying specific numerical values to the zoom lens according to the third embodiment, FIG. 10 showing a spherical aberration, an astigmatism, and a distortion measured at a wide-angle end;

FIG. 11 is a graph showing a spherical aberration, an astigmatism, and a distortion measured at an intermediate focal length;

FIG. 12 is a graph showing a spherical aberration, an astigmatism, and a distortion measured at a telephoto end;

FIG. 13 is a diagram showing a lens construction of a zoom lens according to a fourth embodiment of the present invention;

FIG. 14 is a graph showing, along with FIGS. 15 and 16, aberrations of a fourth numerical embodiment obtained by applying specific numerical values to the zoom lens according to the fourth embodiment, FIG. 14 showing a spherical aberration, an astigmatism, and a distortion measured at a wide-angle end;

FIG. 15 is a graph showing a spherical aberration, an astigmatism, and a distortion measured at an intermediate focal length;

FIG. 16 is a graph showing a spherical aberration, an astigmatism, and a distortion measured at a telephoto end;

FIG. 17 is a diagram showing a lens construction of a zoom lens according to a fifth embodiment of the present invention;

FIG. 18 is a graph showing, along with FIGS. 19 and 20, aberrations of a fifth numerical embodiment obtained by applying specific numerical values to the zoom lens according to the fifth embodiment, FIG. 18 showing a spherical aberration, an astigmatism, and a distortion measured at a wide-angle end;

FIG. 19 is a graph showing a spherical aberration, an astigmatism, and a distortion measured at an intermediate focal length;

FIG. 20 is a graph showing a spherical aberration, an astigmatism, and a distortion measured at a telephoto end; and

FIG. 21 is a block diagram showing an image capture apparatus according to an embodiment of the present invention.

### DETAILED DESCRIPTION OF THE EMBODIMENTS

Embodiments of a zoom lens and an image capture apparatus according to the present invention will be described below with reference to the accompanying drawings.

A zoom lens according to an embodiment of the present invention will be described first.

The zoom lens includes, in the following order from an object side, a first lens group having positive refractive power, a second lens group having negative refractive power, a third lens group having positive refractive power, and a fourth lens group having positive refractive power. During power variation from a wide-angle end, or maximum wide angle state, to a telephoto end, or maximum telephoto state, the first lens group, the third lens group, and the fourth lens group move toward the object side such that the distance between the first lens group and the second lens group increases, the distance between the second lens group and the third lens group decreases, and the distance between the third lens group and the fourth lens group decreases. The zoom lens satisfies the following conditional formulae (1) and (2):

1.8<f3/fw<5, and (1)

−2.5<2×D3/f2<−1.5, (2)

where:
f3 represents a composite focal length of the third lens group,
fw represents a composite focal length of the total system at the wide-angle end,
D3 represents a height from an optical axis of axial rays passing through a surface closest to the object side of the third lens group at the telephoto end, and
f2 represents a composite focal length of the second lens group.

In the zoom lens, by adopting the above-mentioned configuration, it is possible to achieve high performance and compactness, and also ensure sufficient back focus.

The conditional formula (1) is intended to define the focal length of the third lens group. If the conditional formula (1) is satisfied, it is possible to compatibly realize the correction of spherical aberration at the telephoto side and the provision of proper back focus. If the value of f3/fw exceeds the upper limit defined in the conditional formula (1), the refractive power of the third lens group decreases, so that the amount of travel of the third lens group during zooming increases to enlarge the total length of the zoom lens. If the value of f3/fw falls below the lower limit defined in the conditional formula (1), the refractive power of the third lens group increases, so that spherical aberration occurring within the third lens group becomes hard to correct. In addition, it becomes difficult to ensure necessary back focus at the wide-angle end.

The conditional formula (2) is intended to define a ratio of the focal length of the second lens group and the height from the optical axis of axial rays passing through the surface closest to the object side of the third lens group at the telephoto end. If the conditional formula (2) is satisfied, it is possible to have an optical system with small F-numbers over the entire zooming range, while properly correcting spherical aberration at the telephoto end. If the value of 2×D3/f2 exceeds the upper limit defined in the conditional formula (2), the refractive power of the second lens group decreases, so that it becomes difficult to ensure illuminance at the wide-angle side. If the value of 2×D3/f2 falls below the lower limit defined in the conditional formula (2), the position at which the axial rays passing through the surface closest to the object side of the third lens group at the telephoto side becomes high, so that the spherical aberration becomes hard to correct. In addition, the refractive power of the second lens group increases excessively, so that it becomes difficult to correct distortion at the wide-angle side in particular.

In the zoom lens, it is desirable to satisfy the following conditional formula (3), along with the conditional formulae (1) and (2):

−0.8<f2/fw<−0.2. (3)

The conditional formula (3) is intended to define a focal length of the second lens group. If the conditional formula (3) is satisfied, it is possible to compatibly realize the correction of curvature of field at the wide-angle side and the provision of proper back focus. If the value of f2/fw exceeds the upper limit defined in the conditional formula (3), the refractive power of the second lens group decreases, so that it becomes difficult to ensure illuminance at the wide-angle side in particular. If the value of f2/fw falls below the lower limit defined in the conditional formula (3), the refractive power of the second lens group increases excessively, so that it becomes difficult to correct the curvature of field at the wide-angle side.

In the zoom lens, it is further desirable to satisfy the following conditional formula (4), along with the conditional formulae (1) and (2):

1.2<β2w/β2t<1.7, (4)

where:
β2w represents a transverse magnification of the second lens group at the wide-angle end, and
β2t represents a transverse magnification of the second lens group at the telephoto end.

The conditional formula (4) is intended to define a ratio of the transverse magnification at the wide-angle end and the transverse magnification at the telephoto end, of the second lens group. If the conditional formula (4) is satisfied, it is possible to compatibly realize the correction of spherical aberration at the telephoto side and the implementation of a wider angle of view. If the value of β2w/β2t exceeds the upper limit defined in the conditional formula (4), the burden of zooming becomes excessively heavy at the second lens group, so that it becomes difficult to correct the spherical aberration at the telephoto side. If the value of β2w/β2t falls below the lower limit defined in the conditional formula (4), the burden of zooming at the second lens group becomes small, so that when the zoom lens is implemented with a wider angle, its total length increases to hinder its miniaturization.

In the zoom lens, it is desirable to include at least one lens that uses a glass member having a refractive index of not less than 1.9, in any of the third lens group and the fourth lens group. For example, use of a glass member having a refractive index of not less than 1.9 in a negative lens can reduce the curvature of the negative lens, allowing the occurrence of comatic aberration to be decreased in particular.

In the zoom lens, it is further desirable to move the second lens group along the optical axis to perform focusing. By moving the second lens group in a direction of the optical axis to perform focusing, an amount of travel during focusing at the wide-angle end can be decreased, and a large amount of travel during focusing at the telephoto end can be ensured. Accordingly, the minimum image-taking distance can be shortened, with the compactness of the zoom lens maintained.

In the zoom lens, it is further desirable to include at least one aspherical surface within the second lens group. Accordingly, it is possible to correct both distortion at the wide-angle side and spherical aberration at the telephoto side satisfactorily.

Particularly, it is desirable that the aspherical surface provided within the second lens group satisfy the following conditional formula (5):

2<(|X|−|X0|)/(C0×(N′−N)×f2)<30, (5)

where:
X represents a surface shape of the aspherical surface,
X0 represents a reference spherical surface shape of the aspherical surface,
C0 represents a curvature of the reference spherical surface of the aspherical surface,
N represents a refractive index of an object-side medium of the aspherical surface, and
N′ represents a refractive index of an image-side medium of the aspherical surface.

The conditional formula (5) is intended to define the aspherical surface provided on the object side of the second lens group so as to make the positive refractive power stronger as the second lens group moves away from the optical axis. If the conditional formula (5) is satisfied, it is possible to correct distortion at the wide-angle side and spherical aberration at the telephoto side satisfactorily. If the value of (|X↑−|X0|)/(C0×(N′−N)×f2) exceeds the upper limit defined in the conditional formula (5), the power of the aspherical surface increases excessively, so that it becomes difficult to correct the spherical aberration at the telephoto side. If the value of (|X|−|X0|)/(C0×(N′−N)×f2) falls below the lower limit defined in the conditional formula (5), the power of the aspherical surface decreases excessively, so that it becomes difficult to correct the distortion at the wide-angle side.

Specific embodiments of the zoom lens according to the present invention, and numerical embodiments obtained by applying specific numerical values to these embodiments will be described next with reference to the drawings and tables.

Note that an aspherical surface is introduced to each of the embodiments, and that the aspherical surface is to be defined by the following formula 1.

[Formula 1]

$$X = \frac{{y}^{2} \cdot {c}^{2}}{1 + \sqrt{1 - ɛ \cdot {y}^{2} \cdot {c}^{2}}} + \sum {A}^{i} \cdot {Y}^{i}$$

In the formula 1, x represents a distance in a direction of an optical axis from the vertex of a lens surface, y represents a height as viewed in a direction perpendicular to the optical axis, c represents a paraxial curvature at the vertex of the lens surface, ε represents a cone constant, and Aⁱ represents an i-th-order aspherical coefficient.

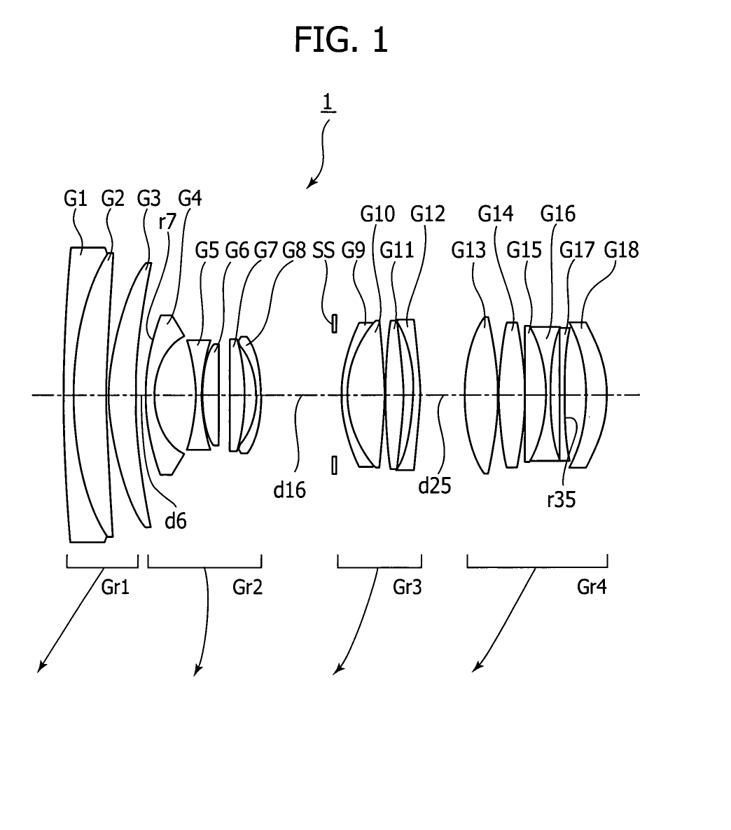

FIG. 1 shows a lens construction at the wide-angle end of a zoom lens 1 according to a first embodiment, indicating, with arrows, motion loci of its constituent lens groups along the optical axis toward the telephoto end, respectively.

The zoom lens 1 includes, in the following order from the object side, a first lens group Gr1 having positive refractive power; a second lens group Gr2 having negative refractive power; a third lens group Gr3 having positive refractive power; and a fourth lens group Gr4 having positive refractive power. During zooming from the wide-angle end to the telephoto end, the first to fourth lens groups move toward the object side as indicated by the arrows, respectively, in FIG. 1 such that a distance between the first lens group Gr1 and the second lens group Gr2 increases, a distance between the second lens group Gr2 and the third lens group Gr3 decreases, and a distance between the third lens group Gr3 and the fourth lens group Gr4 decreases. Further, the second lens group Gr2 moves along the optical axis to perform focusing.

The first lens group Gr1 includes, in the following order from the object side, a cemented negative lens made of a negative meniscus lens G1 and a positive meniscus lens G2, each having a convex surface facing the object side, and a positive meniscus lens G3 having a convex surface facing the object side. The second lens group Gr2 includes, in the following order from the object side, a negative meniscus lens G4 having a convex surface facing the object side and having the object-side surface formed of an aspherical surface, a biconcave negative lens G5, a biconvex positive lens G6, a biconvex positive lens G7, and a negative meniscus lens G8 having a concave surface facing the object side. The third lens group Gr3 includes, in the following order from the object side, a cemented positive lens made of a negative meniscus lens G9 having a convex surface facing the object side and a biconvex positive lens G10, a biconvex positive lens G11, and a negative meniscus lens G12 having a concave surface facing the object side. The fourth lens group Gr4 includes, in the following order from the object side, a biconvex positive lens G13, a biconvex positive lens G14, a cemented negative lens made of a biconvex positive lens G15 and a biconcave negative lens G16, a positive meniscus lens G17 having a convex surface facing the object side, and a positive meniscus lens G18 having a concave surface facing the object side. Further, an aperture stop SS is arranged in proximity to the object side of the third lens group Gr3. The aperture stop SS moves together with the third lens group Gr3.

Table 1 shows lens data of a first numerical embodiment in which specific numerical values are applied to the zoom lens 1 according to the first embodiment. In Table 1 and other lens-data tables, “ri” denotes a paraxial radius of curvature of an i-th surface counted from the object side, “di” denotes an axial surface distance between the i-th surface and an (i+1)-th surface, “Ni” denotes a refractive index, relative to d-line, of an i-th glass member counted from the object side, and “νi” denotes an Abbe number, relative to d-line, of the i-th glass member counted from the object side. The “variable” for “di” means that the axial surface distance is variable. In addition, any lens-cementing material is deemed as a medium in a cemented lens, and “ri”, “di”, “Ni”, and “νi” are also indicated for each cementing material.

TABLE 1

| | AXIAL | | |
|---|---|---|---|
| RADIUS OF | SURFACE | REFRACTIVE | ABBE |
| CURVATURE | DISTANCE | INDEX | NUMBER |
| r1 = 380.826 | d1 = 2.000 | N1 = 1.84666 | ν1 = 23.78 |
| r2 = 72.247 | d2 = 0.010 | N2 = 1.51400 | ν2 = 42.83 |
| r3 = 72.247 | d3 = 7.100 | N3 = 1.83481 | ν3 = 42.72 |
| r4 = 361.349 | d4 = 0.150 | | |
| r5 = 55.736 | d5 = 6.308 | N4 = 1.83481 | ν4 = 42.72 |
| r6 = 142.399 | d6 = variable | | |
| r7 = 81.675 | d7 = 1.550 | N5 = 1.77250 | ν5 = 49.36 |
| r8 = 17.045 | d8 = 9.071 | | |
| r9 = −35.884 | d9 = 1.200 | N6 = 1.81600 | ν6 = 46.57 |
| r10 = 49.580 | d10 = 0.150 | | |
| r11 = 40.297 | d11 = 3.363 | N7 = 1.84666 | ν7 = 23.78 |
| r12 = −1842.842 | d12 = 2.271 | | |
| r13 = 846.797 | d13 = 3.127 | N8 = 1.84666 | ν8 = 23.78 |
| r14 = −62.996 | d14 = 2.682 | | |
| r15 = −20.247 | d15 = 1.000 | N9 = 1.80420 | ν9 = 46.50 |
| r16 = −33.685 | d16 = variable | | |
| r17 = aperture stop | d17 = 1.500 | | |
| r18 = 38.026 | d18 = 1.000 | N10 = 1.88300 | ν10 = 40.80 |
| r19 = 24.805 | d19 = 0.010 | N11 = 1.51400 | ν11 = 42.83 |
| r20 = 24.805 | d20 = 8.112 | N12 = 1.56883 | ν12 = 56.04 |
| r21 = −86.242 | d21 = 0.150 | | |
| r22 = 130.849 | d22 = 3.554 | N13 = 1.83481 | ν13 = 42.72 |
| r23 = −120.044 | d23 = 2.170 | | |
| r24 = −44.185 | d24 = 1.200 | N14 = 1.90366 | ν14 = 31.32 |
| r25 = −12.208 | d25 = variable | | |
| r26 = 36.740 | d26 = 7.294 | N15 = 1.49700 | ν15 = 81.61 |
| r27 = −72.517 | d27 = 0.150 | | |
| r28 = 64.658 | d28 = 5.476 | N16 = 1.49700 | ν16 = 81.61 |
| r29 = −90.184 | d29 = 0.150 | | |
| r30 = 2222717 | d30 = 4.108 | N17 = 1.48749 | ν17 = 70.44 |
| r31 = −37.457 | d31 = 0.010 | N18 = 1.51400 | ν18 = 42.83 |
| r32 = −37.457 | d32 = 1.000 | N19 = 1.90366 | ν19 = 31.32 |
| r33 = 53.948 | d33 = 1.726 | | |
| r34 = 260.760 | d34 = 1.350 | N20 = 1.77250 | ν20 = 49.36 |
| r35 = 660.611 | d35 = 3.935 | | |
| r36 = −44.092 | d36 = 4.533 | N21 = 1.84666 | ν21 = 23.78 |
| r37 = −31.997 | | | |

In Table 1, N2, ν2, N11, ν11, N18, and ν18 denote the refractive indexes and the Abbe numbers of cementing materials in the cemented lenses. Further, the negative meniscus lens G12 positioned closest to an image side in the third lens group Gr3 and the biconcave lens G16 on the image side of the cemented negative lens in the fourth lens group Gr4 are formed of glass members having refractive indexes of not less than 1.9, respectively.

The distance d6 between the first lens group Gr1 and the second lens group Gr2, the distance d16 between the second lens group Gr2 and the aperture stop SS, and the distance d25 between the third lens group Gr3 and the fourth lens group Gr4 vary during zooming from the wide-angle end to the telephoto end. The values of the respective distances d6, d16, and d25 in the first numerical embodiment measured at a wide-angle end (f=24.70), at an intermediate focal length (f=38.02) between the wide-angle end and a telephoto end, and at the telephoto end (f=68.28) are shown in Table 2 along with focal lengths f, F-numbers FNO, and angles of view 2ω.

TABLE 2

| | | | |
|---|---|---|---|
| f | 24.70 | 38.02 | 68.28 |
| FNO | 2.88 | 2.88 | 2.90 |
| 2ω | 83.6 | 59.0 | 34.3 |
| d6 | 2.139 | 10.121 | 28.794 |
| d16 | 16.107 | 7.458 | 1.200 |
| d25 | 9.686 | 4.008 | 1.300 |

A surface r7 closest to the object side of the second lens group Gr2, i.e., an object-side surface of the negative meniscus lens G4, and an image-side surface r35 of the positive meniscus lens G17 of the fourth lens group Gr4 are formed of aspherical surfaces. Aspherical coefficients of the above-mentioned surfaces in the first numerical embodiment are shown in Table 3 along with cone constants ε.

TABLE 3
ASPHERICAL COEFFICIENTS

r7
ε = 1.0000
A4 = 0.93997750 × 10⁻⁵
A6 = −0.12988167 × 10⁻⁷
A8 = 0.88123738 × 10⁻¹⁰
A10 = −0.27645578 × 10⁻¹²
A12 = 0.46516027 × 10⁻¹⁵
r35
ε = 1.0000
A4 = 0.17330725 × 10⁻⁴
A6 = 0.40381324 × 10⁻⁸
A8 = 0.28797489 × 10⁻¹⁰
A10 = −0.54060164 × 10⁻¹³

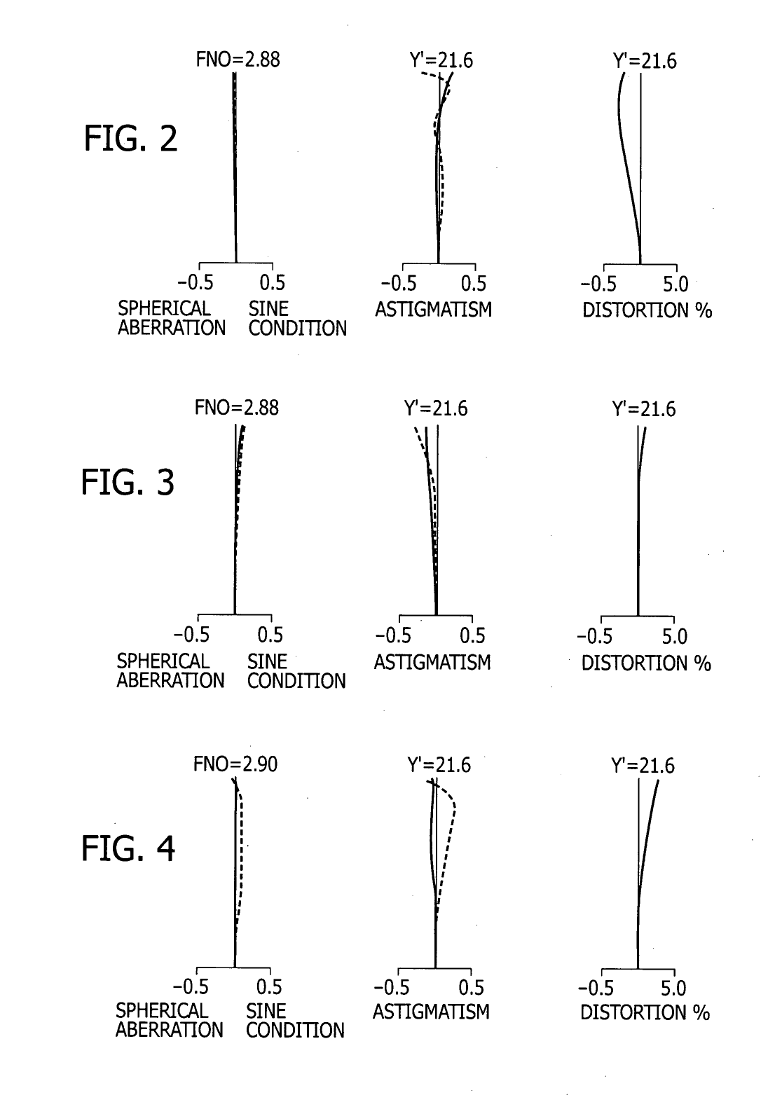

Each of FIGS. 2 to 4 shows a spherical aberration, an astigmatism, and a distortion in the first numerical embodiment which is in focus at infinity. FIG. 2 shows the aberrations measured at the wide-angle end, FIG. 3 shows the aberrations measured at the intermediate focal length, and FIG. 4 shows the aberrations measured at the telephoto end. In each of the spherical-aberration graphs, a solid line represents a spherical aberration at d-line and a dashed line represents a sine condition. In each of the astigmatism graphs, a solid line represents a sagittal image plane and a dashed line represents a meridional image plane.

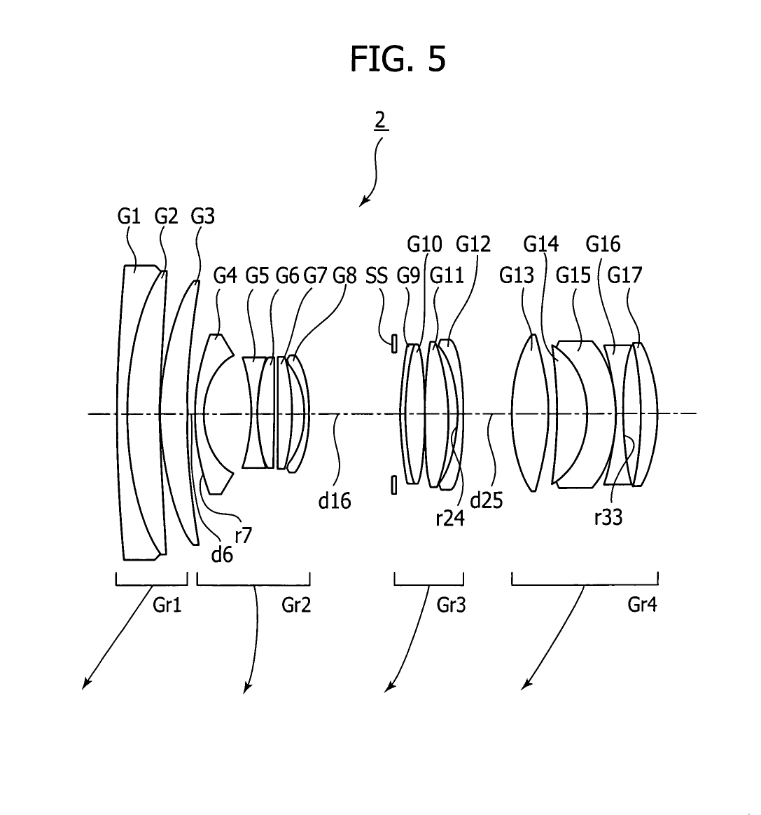

FIG. 5 shows a lens construction at the wide-angle end of a zoom lens 2 according to a second embodiment, indicating, with arrows, motion loci of its constituent lens groups along the optical axis toward the telephoto end, respectively.

The zoom lens 2 includes, in the following order from the object side, a first lens group Gr1 having positive refractive power, a second lens group Gr2 having negative refractive power, a third lens group Gr3 having positive refractive power, and a fourth lens group Gr4 having positive refractive power. During zooming from the wide-angle end to the telephoto end, the first to fourth lens groups move toward the object side as indicated by the arrows, respectively, in FIG. 5 such that a distance between the first lens group Gr1 and the second lens group Gr2 increases, a distance between the second lens group Gr2 and the third lens group Gr3 decreases, and a distance between the third lens group Gr3 and the fourth lens group Gr4 decreases. Further, the second lens group Gr2 moves along the optical axis to perform focusing.

The first lens group Gr1 includes, in the following order from the object side, a cemented positive lens made of a negative meniscus lens G1 and a positive meniscus lens G2, each having a convex surface facing the object side, and a positive meniscus lens G3 having a convex surface facing the object side. The second lens group Gr2 includes, in the following order from the object side, a negative meniscus lens G4 having a convex surface facing the object side and having the object-side surface formed of an aspherical surface, a biconvex negative lens G5, a biconvex positive lens G6, a biconvex positive lens G7, and a negative meniscus lens G8 having a convex surface facing the image side. The third lens group Gr3 includes, in the following order from the object side, a cemented positive lens made of a negative meniscus lens G9 having a convex surface facing the object side and a biconvex positive lens G10, a biconvex positive lens G11, and a negative meniscus lens G12 having a convex surface facing the image side and an object-side surface formed of an aspherical surface. The fourth lens group Gr4 includes, in the following order from the object side, a biconvex positive lens G13, a cemented positive lens made of a positive meniscus lens G14 and a negative meniscus lens G15, each having a convex surface facing the image side, a biconcave negative lens G16 having an image-side surface formed of an aspherical surface, and a positive meniscus lens G17 having a convex surface facing the image side. Further, an aperture stop SS is arranged in proximity to the object side of the third lens group Gr3. The aperture stop SS moves together with the third lens group Gr3.

Table 4 shows lens data of a second numerical embodiment in which specific numerical values are applied to the zoom lens 2 according to the second embodiment.

TABLE 4

| | AXIAL | | |
|---|---|---|---|
| RADIUS OF | SURFACE | REFRACTIVE | ABBE |
| CURVATURE | DISTANCE | INDEX | NUMBER |
| r1 = 220.968 | d1 = 2.000 | N1 = 1.84666 | ν1 = 23.78 |
| r2 = 67.344 | d2 = 0.010 | N2 = 1.51400 | ν2 = 42.83 |
| r3 = 67.344 | d3 = 7.100 | N3 = 1.83481 | ν3 = 42.72 |
| r4 = 188.081 | d4 = 0.150 | | |
| r5 = 61.075 | d5 = 5.884 | N4 = 1.83481 | ν4 = 42.72 |
| r6 = 160.241 | d6 = variable | | |
| r7 = 80.589 | d7 = 1.550 | N5 = 1.77250 | ν5 = 49.36 |
| r8 = 17.614 | d8 = 10.462 | | |
| r9 = −32.223 | d9 = 1.200 | N6 = 1.81600 | ν6 = 46.57 |
| r10 = 54.199 | d10 = 0.150 | | |
| r11 = 47.963 | d11 = 3.940 | N7 = 1.84666 | ν7 = 23.78 |
| r12 = −158.194 | d12 = 0.323 | | |
| r13 = 569.272 | d13 = 2.886 | N8 = 1.84666 | ν8 = 23.78 |
| r14 = −87.234 | d14 = 2.949 | | |
| r15 = −20.701 | d15 = 1.000 | N9 = 1.75500 | ν9 = 52.32 |
| r16 = −29.479 | d16 = variable | | |
| r17 = aperture stop | d17 = 1.500 | | |
| r18 = 80.522 | d18 = 1.000 | N10 = 1.90366 | ν10 = 31.32 |
| r19 = 63.033 | d19 = 0.010 | N11 = 1.51400 | ν11 = 42.83 |
| r20 = 63.033 | d20 = 4.128 | N12 = 1.72916 | ν12 = 54.67 |
| r21 = −122.978 | d21 = 0.150 | | |
| r22 = 118.691 | d22 = 4.799 | N13 = 1.63854 | ν13 = 55.45 |
| r23 = −53.257 | d23 = 2.192 | | |
| r24 = −29.020 | d24 = 1.200 | N14 = 1.81359 | ν14 = 25.73 |
| r25 = −53.543 | d25 = variable | | |
| r26 = 33.948 | d26 = 8.000 | N15 = 1.49700 | ν15 = 81.61 |
| r27 = −52.406 | d27 = 1.681 | | |
| r28 = −152.975 | d28 = 6.261 | N16 = 1.49700 | ν16 = 81.61 |
| r29 = −20.731 | d29 = 0.010 | N17 = 1.51400 | ν17 = 42.83 |
| r30 = −20.731 | d30 = 6.225 | N18 = 1.83481 | ν18 = 42.72 |
| r31 = −30.059 | d31 = 0.150 | | |
| r32 = −45.676 | d32 = 1.500 | N19 = 1.77250 | ν19 = 49.36 |
| r33 = 123.139 | d33 = 3.473 | | |
| r34 = −87.572 | d34 = 3.491 | N20 = 1.49700 | ν20 = 81.61 |
| r35 = −38.612 | | | |

In Table 4, N2, ν2, N11, ν11, N17, and ν17 denote the refractive indexes and the Abbe numbers of cementing materials in the cemented lenses. Further, the negative meniscus lens G9 on the object side of the cemented positive lens in the third lens group Gr3 is formed of a glass member having a refractive index of not less than 1.9.

The distance d6 between the first lens group Gr1 and the second lens group Gr2, the distance d16 between the second lens group Gr2 and the aperture stop SS, and the distance d25 between the third lens group Gr3 and the fourth lens group Gr4 vary during zooming from the wide-angle end to the telephoto end. The values of the respective distances d6, d16, and d25 in the second numerical embodiment measured at a wide-angle end (f=24.70), at an intermediate focal length (f=38.02) between the wide-angle end and a telephoto end, and at the telephoto end (f=68.28) are shown in Table 5 along with focal lengths f, F-numbers FNO, and angles of view 2ω.

TABLE 5

| | | | |
|---|---|---|---|
| f | 24.70 | 38.02 | 68.28 |
| FNO | 2.88 | 2.88 | 2.90 |
| 2ω | 83.9 | 59.0 | 34.3 |
| d6 | 2.030 | 9.776 | 32.586 |
| d16 | 17.990 | 7.910 | 1.200 |
| d25 | 9.848 | 3.901 | 1.300 |

A surface r7 closest to the object side of the second lens group Gr2, i.e., an object-side surface of the negative meniscus lens G4, an object-side surface r24 of the negative meniscus lens G12 positioned closest to the image side of the third lens group Gr3, and an image-side surface r33 of the biconcave negative lens G16 of the fourth lens group Gr4 are formed of aspherical surfaces. Aspherical coefficients of the above-mentioned surfaces in the second numerical embodiment are shown in Table 6 along with cone constants ε.

TABLE 6
ASPHERICAL COEFFICIENTS

r7
ε = 1.0000
A4 = 0.87992287 × 10⁻⁵
A6 = −0.11175195 × 10⁻⁷
A8 = 0.72787399 × 10⁻¹⁰
A10 = −0.21911883 × 10⁻¹²
A12 = 0.34465493 × 10⁻¹⁵
r24
ε = 1.0000
A4 = 0.35660889 × 10⁻⁵
A6 = 0.19876078 × 10⁻⁸
A8 = 0.72664799 × 10⁻¹¹
A10 = −0.23243164 × 10⁻¹³
r33
ε = 1.0000
A4 = 0.17259768 × 10⁻⁴
A6 = 0.37358412 × 10⁻⁸
A8 = 0.23493941 × 10⁻¹⁰
A10 = −0.42928514 × 10⁻¹³

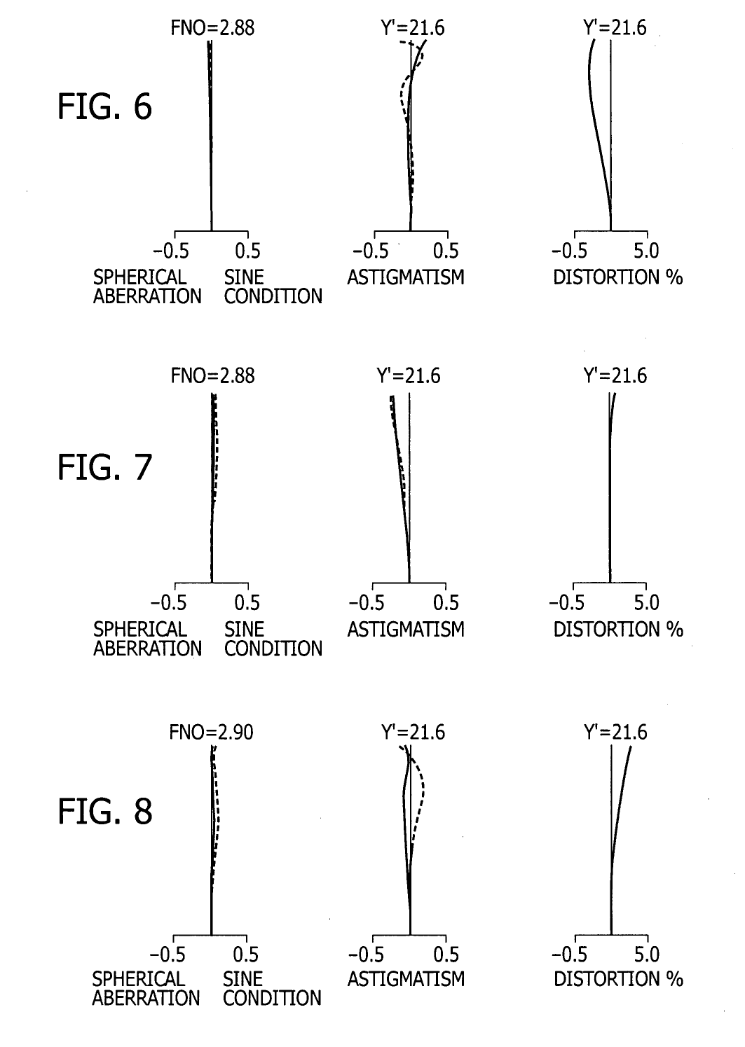

Each of FIGS. 6 to 8 shows a spherical aberration, an astigmatism, and a distortion in the second numeral embodiment which is in focus at infinity. FIG. 6 shows the aberrations measured at the wide-angle end. FIG. 7 shows the aberrations measured at the intermediate focal length. FIG. 8 shows the aberrations measured at the telephoto end. In each of the spherical-aberration graphs, a solid line represents a spherical aberration at d-line, and a dashed line represents a sine condition. In each of the astigmatism graphs, a solid line represents a sagittal image plane and a dashed line represents a meridional image plane.

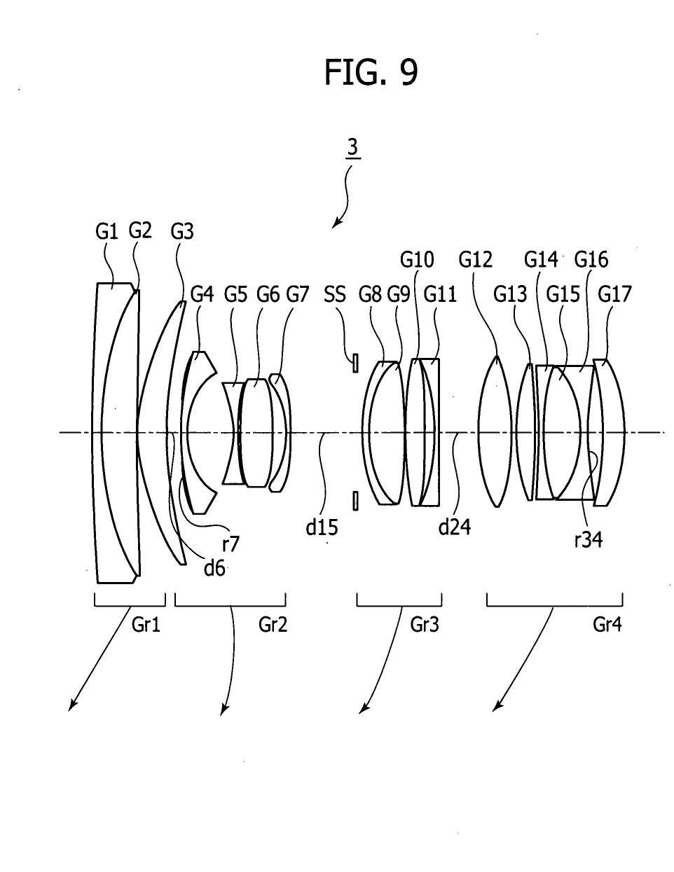

FIG. 9 shows a lens construction at the wide-angle end of a zoom lens 3 according to a third embodiment, indicating, with arrows, motion loci of its constituent lens groups along the optical axis toward the telephoto end, respectively.

The zoom lens 3 includes, in the following order from the object side, a first lens group Gr1 having positive refractive power, a second lens group Gr2 having negative refractive power, a third lens group Gr3 having positive refractive power, and a fourth lens group Gr4 having positive refractive power. During zooming from the wide-angle end to the telephoto end, the first to fourth lens groups move toward the object side as indicated by the arrows, respectively, in FIG. 9 such that a distance between the first lens group Gr1 and the second lens group Gr2 increases, a distance between the second lens group Gr2 and the third lens group Gr3 decreases, and a distance between the third lens group Gr3 and the fourth lens group Gr4 decreases. Further, the second lens group Gr2 moves along the optical axis to perform focusing.

The first lens group Gr1 includes, in the following order from the object side, a cemented positive lens made of a negative meniscus lens G1 and a positive meniscus lens G2, each having a convex surface facing the object side, and a positive meniscus lens G3 having a convex surface facing the object side. The second lens group Gr2 includes, in the following order from the object side, a negative meniscus lens G4, a biconcave negative lens G5, a biconvex positive lens G6, and a negative meniscus lens G7 having a convex surface facing the image side. The lens G4 has a convex surface facing the object side, and also has a resin layer formed on an object-side surface, the resin layer having an object-side surface thereof formed of an aspherical surface. The third lens group Gr3 includes, in the following order from the object side, a cemented positive lens made of a negative meniscus lens G8 having a convex surface facing the object side and a biconvex positive lens G9, a biconvex positive lens G10, and a negative meniscus lens G11 having a convex surface facing the image side. The fourth lens group Gr4 includes, in the following order from the object side, a biconvex positive lens G12, a biconvex positive lens G13, a cemented-triplet negative lens, and a positive meniscus lens G17 having a convex surface facing the image side. The cemented-triplet negative lens block includes, in the following order from the object side, a biconcave negative lens G14, a biconvex positive lens G15, and a biconcave negative lens G16 having an image-side surface formed of an aspherical surface. Further, an aperture stop SS is arranged in the proximity to the object side of the third lens group Gr3. The aperture stop SS moves together with the third lens group Gr3.

Table 7 shows lens data of a third numerical embodiment in which specific numerical values are applied to the zoom lens 3 according to the third embodiment.

TABLE 7

| | AXIAL | | |
|---|---|---|---|
| RADIUS OF | SURFACE | REFRACTIVE | ABBE |
| CURVATURE | DISTANCE | INDEX | NUMBER |
| r1 = 499.925 | d1 = 1.800 | N1 = 1.84666 | ν1 = 23.78 |
| r2 = 70.243 | d2 = 0.010 | N2 = 1.51400 | ν2 = 42.83 |
| r3 = 70.243 | d3 = 7.839 | N3 = 1.83481 | ν3 = 42.72 |
| r4 = 702.158 | d4 = 0.150 | | |
| r5 = 51.782 | d5 = 6.482 | N4 = 1.83481 | ν4 = 42.72 |
| r6 = 127.256 | d6 = variable | | |
| r7 = 129.646 | d7 = 0.200 | N5 = 1.51460 | ν5 = 49.96 |
| r8 = 66.952 | d8 = 1.100 | N6 = 1.83481 | ν6 = 42.72 |
| r9 = 16.638 | d9 = 10.242 | | |
| r10 = −27.950 | d10 = 1.200 | N7 = 1.77250 | ν7 = 49.62 |
| r11 = 67.191 | d11 = 0.150 | | |
| r12 = 50.306 | d12 = 7.570 | N8 = 1.84666 | ν8 = 23.78 |
| r13 = −37.485 | d13 = 2.475 | | |
| r14 = −21.750 | d14 = 1.000 | N9 = 1.80420 | ν9 = 46.50 |
| r15 = −42.712 | d15 = variable | | |
| r16 = aperture stop | d16 = 1.500 | | |
| r17 = 37.205 | d17 = 1.000 | N10 = 1.88300 | ν10 = 40.80 |
| r18 = 24.392 | d18 = 0.010 | N11 = 1.51400 | ν11 = 42.83 |
| r19 = 24.392 | d19 = 8.279 | N12 = 1.56883 | ν12 = 56.04 |
| r20 = −75.238 | d20 = 0.150 | | |
| r21 = 88.368 | d21 = 3.765 | N13 = 1.83481 | ν13 = 42.72 |
| r22 = −140.100 | d22 = 2.200 | | |
| r23 = −44.921 | d23 = 1.200 | N14 = 1.90366 | ν14 = 31.32 |
| r24 = −280.758 | d24 = variable | | |
| r25 = 38.490 | d25 = 7.474 | N15 = 1.49700 | ν15 = 81.61 |
| r26 = −50.523 | d26 = 1.120 | | |
| r27 = 48.357 | d27 = 3.844 | N16 = 1.49700 | ν16 = 81.61 |
| r28 = −260.303 | d28 = 1.161 | | |
| r29 = −180.563 | d29 = 0.950 | N17 = 1.90366 | ν17 = 31.32 |
| r30 = 52.719 | d30 = 0.000 | N18 = 1.51400 | ν18 = 42.83 |
| r31 = 52.719 | d31 = 8.000 | N19 = 1.49700 | ν19 = 81.61 |
| r32 = −23.235 | d32 = 0.000 | N20 = 1.51400 | ν20 = 42.83 |
| r33 = −23.235 | d33 = 1.600 | N21 = 1.77250 | ν21 = 49.36 |
| r34 = −181.172 | d34 = 3.136 | | |
| r35 = −70.591 | d35 = 4.743 | N22 = 1.90366 | ν22 = 31.32 |
| r36 = −36.247 | | | |

In Table 7, N2, μ2, N11, ν11, N18, ν18, N20, and ν20 denote the refractive indexes and the Abbe numbers of cementing materials in the cemented lenses. Further, the negative meniscus lens G11 closest to the image side of the third lens group Gr3, the biconcave lens G14 on the object side of the cemented triplet of the fourth lens group Gr4, and the positive meniscus lens G17 closest to the image side of the fourth lens group Gr4 are formed of glass members having refractive indexes of not less than 1.9, respectively.

The distance d6 between the first lens group Gr1 and the second lens group Gr2, the distance d15 between the second lens group Gr2 and the aperture stop SS, and the distance d24 between the third lens group Gr3 and the fourth lens group Gr4 vary during zooming from the wide-angle end to the telephoto end. The values of the respective distances d6, d15, and d24 in the third numerical embodiment measured at a wide-angle end (f=24.70), at an intermediate focal length (f=37.98) between the wide-angle end and a telephoto end, and at the telephoto end (f=68.28) are shown in Table 8 along with focal lengths f, F-numbers FNO, and angles of view 2ω.

TABLE 8

| | | | |
|---|---|---|---|
| f | 24.70 | 37.98 | 68.28 |
| FNO | 2.88 | 2.88 | 2.90 |
| 2ω | 83.6 | 58.8 | 34.3 |
| d6 | 2.667 | 11.578 | 27.552 |
| d15 | 14.555 | 7.229 | 1.200 |
| d24 | 8.110 | 3.155 | 0.500 |

A surface closest to the object side of the second lens group Gr2, i.e., an object-side surface r7 of the resin layer formed on the object-side surface of the negative meniscus lens G4, and an image-side surface r34 of the cemented-triplet negative lens of the fourth lens group Gr4, i.e., the image-side surface of the biconcave negative lens G16, are formed of aspherical surfaces. Aspherical coefficients of the above-mentioned surfaces in the third numerical embodiment are shown in Table 9 along with cone constants ε.

TABLE 9
ASPHERICAL COEFFICIENTS

r7
ε = 1.0000
A4 = 0.17178371 × 10⁻⁴
A6 = −0.34835652 × 10⁻⁷
A8 = 0.16518227 × 10⁻⁹
A10 = −0.47170207 × 10⁻¹²
A12 = 0.74692047 × 10⁻¹⁵
r34
ε = 1.0000
A4 = 0.16716100 × 10⁻⁴
A6 = −0.20740902 × 10⁻⁸
A8 = 0.86242802 × 10⁻¹¹
A10 = −0.34989489 × 10⁻¹³

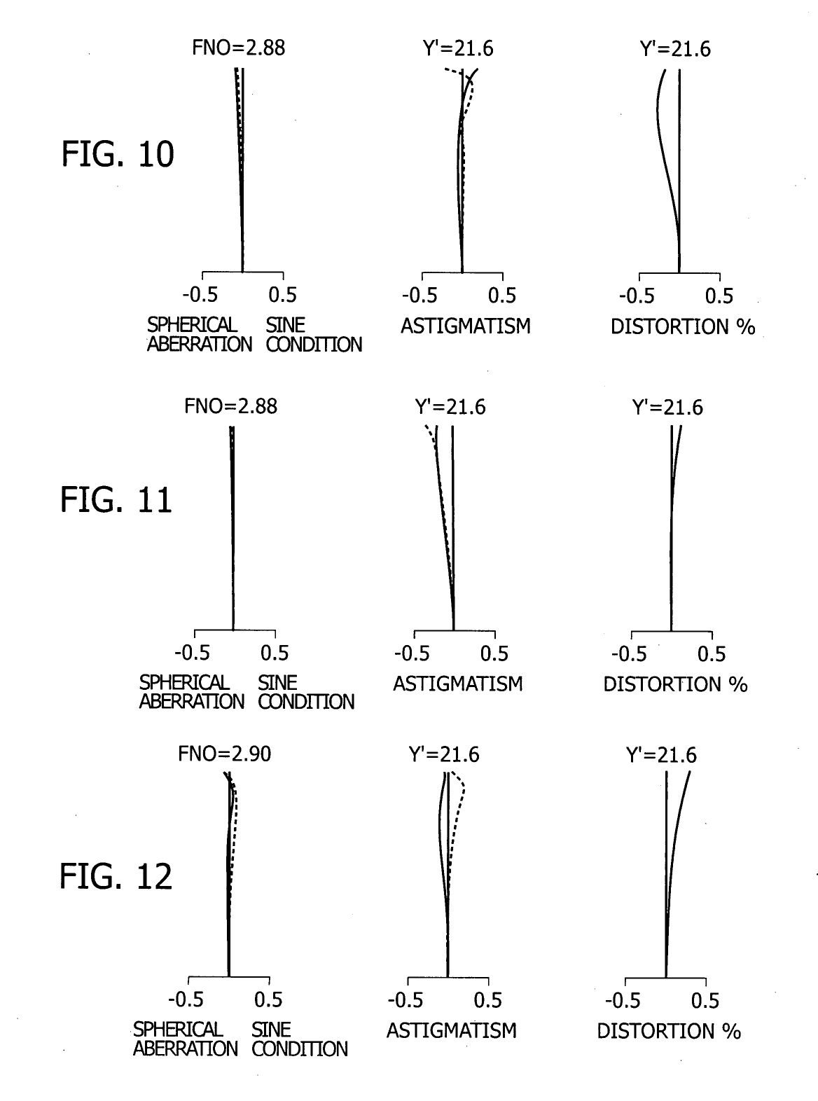

Each of FIGS. 10 to 12 shows a spherical aberration, an astigmatism, and a distortion in the third numerical embodiment which is in focus at infinity. FIG. 10 shows the aberrations measured at the wide-angle end, FIG. 11 shows the aberrations measured at the intermediate focal length, and FIG. 12 shows the aberrations measured at the telephoto end. In each of the spherical-aberration graphs, a solid line represents a spherical aberration at d-line and a dashed line represents a sine condition. In each of the astigmatism graphs, a solid line represents a sagittal image plane and a dashed line represents a meridional image plane.

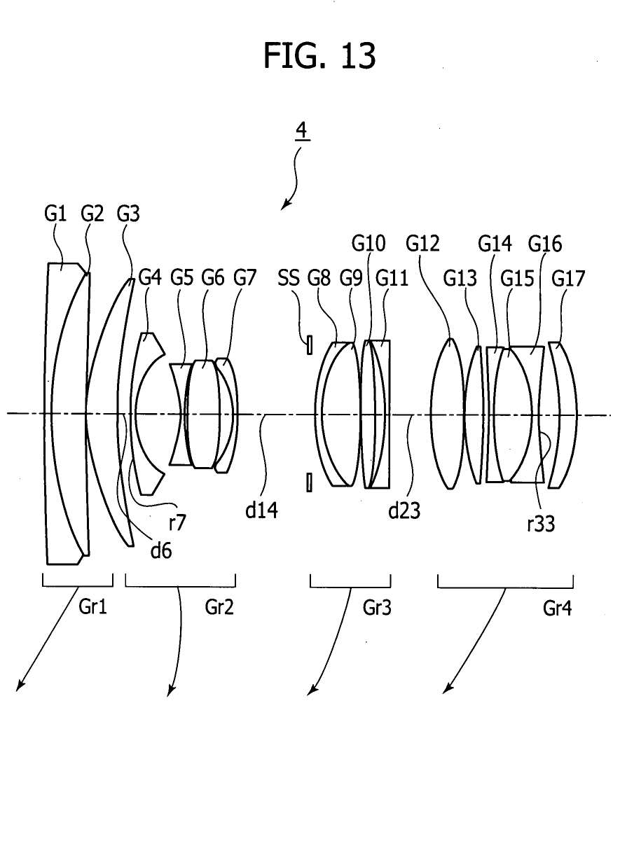

FIG. 13 shows the lens construction at the wide-angle end of a zoom lens 4 according to a fourth embodiment, indicating, with arrows, motion loci of its constituent lens groups along the optical axis toward the telephoto end, respectively.

The zoom lens 4 includes, in the following order from the object side, a first lens group Gr1 having positive refractive power, a second lens group Gr2 having negative refractive power, a third lens group Gr3 having positive refractive power, and a fourth lens group Gr4 having positive refractive power. During zooming from the wide-angle end to the telephoto end, the first to fourth lens groups move toward the object side as indicated by the arrows, respectively, in FIG. 13 such that a distance between the first lens group Gr1 and the second lens group Gr2 increases, a distance between the second lens group Gr2 and the third lens group Gr3 decreases, and a distance between the third lens group Gr3 and the fourth lens group Gr4 decreases. Further, the second lens group Gr2 moves along the optical axis to perform focusing.

The first lens group Gr1 includes, in the following order from the object side, a cemented positive lens made of a negative meniscus lens G1 and a positive meniscus lens G2, each having a convex surface facing the object side, and a positive meniscus lens G3 having a convex surface facing the object side. The second lens group Gr2 includes, in the following order from the object side, a negative meniscus lens G4 having a convex surface facing the object side and having the object-side surface formed of an aspherical surface, a biconcave negative lens G5, a biconvex positive lens G6, and a negative meniscus lens G7 having a convex surface facing the image side. The third lens group Gr3 includes, in the following order from the object side, a cemented positive lens made of a negative meniscus lens G8 having a convex surface facing the object side and a biconvex positive lens G9, a biconvex positive lens G10, and a negative meniscus lens G11 having a convex surface facing the image side. The fourth lens group Gr4 includes, in the following order from the object side, a biconvex positive lens G12, a biconvex positive lens G13, a cemented-triplet negative lens, and a positive meniscus lens G17 having a convex surface facing the image side. The cemented-triplet negative lens block includes, in the following order from the object side, a biconcave negative lens G14, a biconvex positive lens G15, and a biconcave negative lens G16 having an image-side surface formed of an aspherical surface. Further, an aperture stop SS is arranged in the proximity to the object side of the third lens group Gr3. The aperture stop SS moves together with the third lens group Gr3.

Table 10 shows lens data of a fourth numerical embodiment in which specific numerical values are applied to the zoom lens 4 according to the fourth embodiment.

TABLE 10

| | AXIAL | | |
|---|---|---|---|
| RADIUS OF | SURFACE | REFRACTIVE | ABBE |
| CURVATURE | DISTANCE | INDEX | NUMBER |
| r1 = 499.870 | d1 = 1.800 | N1 = 1.84666 | ν1 = 23.78 |
| r2 = 72.433 | d2 = 0.010 | N2 = 1.51400 | ν2 = 42.83 |
| r3 = 72.433 | d3 = 7.549 | N3 = 1.83481 | ν3 = 42.72 |
| r4 = 543.957 | d4 = 0.150 | | |
| r5 = 51.875 | d5 = 6.422 | N4 = 1.83481 | ν4 = 42.72 |
| r6 = 120.440 | d6 = variable | | |
| r7 = 101.813 | d7 = 1.300 | N5 = 1.77250 | ν5 = 49.36 |
| r8 = 16.363 | d8 = 9.742 | | |
| r9 = −28.617 | d9 = 1.000 | N6 = 1.75500 | ν6 = 52.32 |
| r10 = 75.219 | d10 = 0.259 | | |
| r11 = 50.587 | d11 = 7.819 | N7 = 1.80518 | ν7 = 25.46 |
| r12 = −40.687 | d12 = 2.355 | | |
| r13 = −20.462 | d13 = 1.000 | N8 = 1.77250 | ν8 = 49.62 |
| r14 = −36.019 | d14 = variable | | |
| r15 = aperture stop | d15 = 1.700 | | |
| r16 = 41.010 | d16 = 1.000 | N9 = 1.88300 | ν9 = 40.80 |
| r17 = 23.512 | d17 = 0.010 | N10 = 1.51400 | ν10 = 42.83 |
| r18 = 23.512 | d18 = 8.316 | N11 = 1.65844 | ν11 = 50.85 |
| r19 = −90.909 | d19 = 0.150 | | |
| r20 = 116.447 | d20 = 3.429 | N12 = 1.83481 | ν12 = 42.72 |
| r21 = −130.962 | d21 = 1.860 | | |
| r22 = −47.713 | d22 = 1.200 | N13 = 1.90366 | ν13 = 31.32 |
| r23 = −328.584 | d23 = variable | | |
| r24 = 36.187 | d24 = 7.840 | N14 = 1.49700 | ν14 = 81.61 |
| r25 = −50.232 | d25 = 0.150 | | |
| r26 = 56.411 | d26 = 3.716 | N15 = 1.49700 | ν15 = 81.61 |
| r27 = −217.711 | d27 = 1.286 | | |
| r28 = −130.474 | d28 = 0.950 | N16 = 1.90366 | ν16 = 31.32 |
| r29 = 59.677 | d29 = 0.010 | N17 = 1.51400 | ν17 = 42.83 |
| r30 = 59.677 | d30 = 8.271 | N18 = 1.48749 | ν18 = 70.44 |
| r31 = −23.811 | d31 = 0.010 | N19 = 1.51400 | ν19 = 42.83 |
| r32 = −23.811 | d32 = 1.450 | N20 = 1.77250 | ν20 = 49.36 |
| r33 = 236.729 | d33 = 4.472 | | |
| r34 = −69.191 | d34 = 3.884 | N21 = 1.83400 | ν21 = 37.34 |
| r35 = −33.324 | | | |

In Table 10, N2, ν2, N10, ν10, N17, ν17, N19, and ν19 denote the refractive indexes and the Abbe numbers of cementing materials in the cemented lenses. Further, the negative meniscus lens G11 closest to the image side of the third lens group Gr3, and the biconcave lens G14 on the object side of the cemented triplet in the fourth lens group Gr4 are formed of glass members having refractive indexes of not less than 1.9, respectively.

The distance d6 between the first lens group Gr1 and the second lens group Gr2, the distance d14 between the second lens group Gr2 and the aperture stop SS, and the distance d23 between the third lens group Gr3 and the fourth lens group Gr4 vary during zooming from the wide-angle end to the telephoto end. The values of the distances d6, d14, and d23 in the fourth numerical embodiment measured at a wide-angle end (f=24.70), at an intermediate focal length (f=37.98) between the wide-angle end and a telephoto end, and at the telephoto end (f=68.28) are shown in Table 11 along with focal lengths f, F-numbers FNO, and angles of view 2ω.

TABLE 11

| | | | |
|---|---|---|---|
| f | 24.70 | 37.98 | 68.28 |
| FNO | 2.89 | 2.89 | 2.91 |
| 2ω | 83.9 | 59.2 | 34.5 |
| d6 | 2.869 | 10.842 | 28.691 |
| d14 | 15.651 | 7.280 | 1.000 |
| d23 | 8.317 | 3.117 | 0.500 |

A surface closest to the object side of the second lens group Gr2, i.e., an object-side surface r7 of the negative meniscus lens G4, and an image-side surface r33 of the cemented-triplet negative lens of the fourth lens group Gr4 are formed of aspherical surfaces. Aspherical coefficients of the above-mentioned surfaces in the fourth numerical embodiment are shown in Table 12 along with cone constants ε.

TABLE 12
ASPHERICAL COEFFICIENTS

r7
ε = 1.0000
A4 = 0.12935357 × 10⁻⁴
A6 = −0.24245077 × 10⁻⁷
A8 = 0.13473347 × 10⁻⁹
A10 = −0.40439169 × 10⁻¹²
A12 = 0.64586668 × 10⁻¹⁵
r33
ε = 1.0000
A4 = 0.17256069 × 10⁻⁴
A6 = −0.25915582 × 10⁻⁸
A8 = 0.10983191 × 10⁻¹⁰
A10 = −0.38855952 × 10⁻¹³

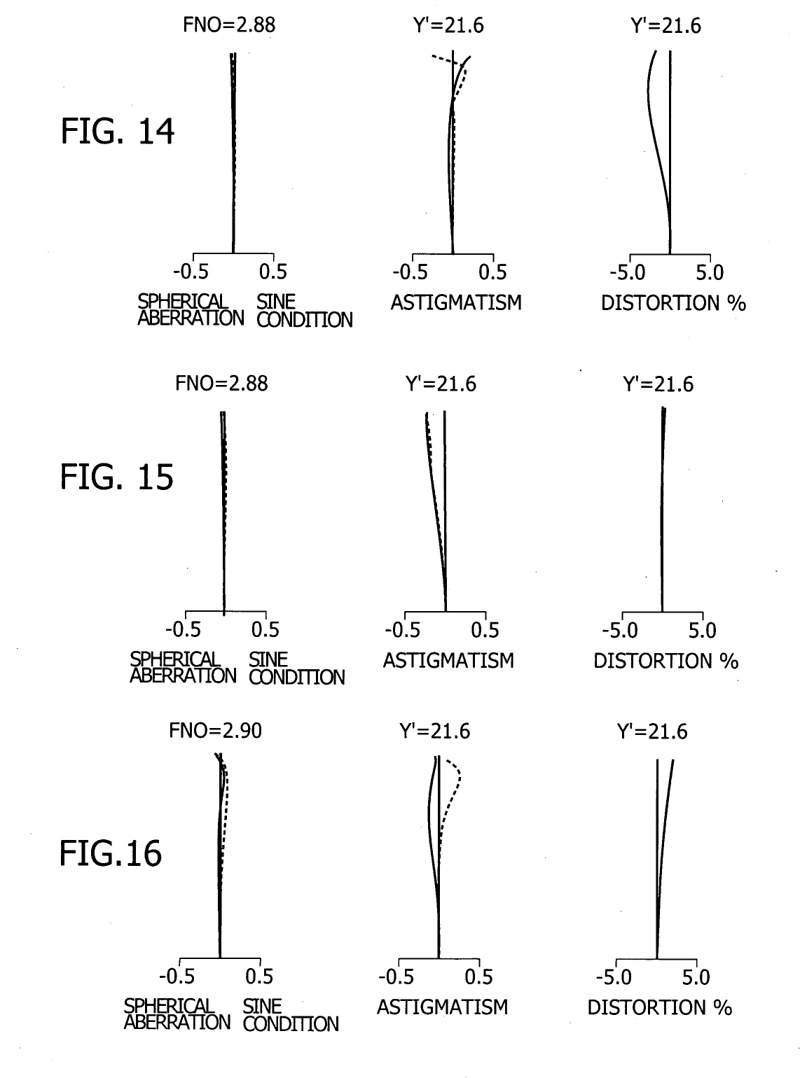

Each of FIGS. 14 to 16 shows a spherical aberration, an astigmatism, and a distortion in the fourth numeral embodiment which is in focus at infinity. FIG. 14 shows the aberrations measured at the wide-angle end. FIG. 15 shows the aberrations measured at the intermediate focal length. FIG. 16 shows the aberrations measured at the telephoto end. In each of the spherical-aberration graphs, a solid line represents a spherical aberration at d-line, and a dashed line represents a sine condition. In each of the astigmatism graphs, a solid line represents a sagittal image plane and a dashed line represents a meridional image plane.

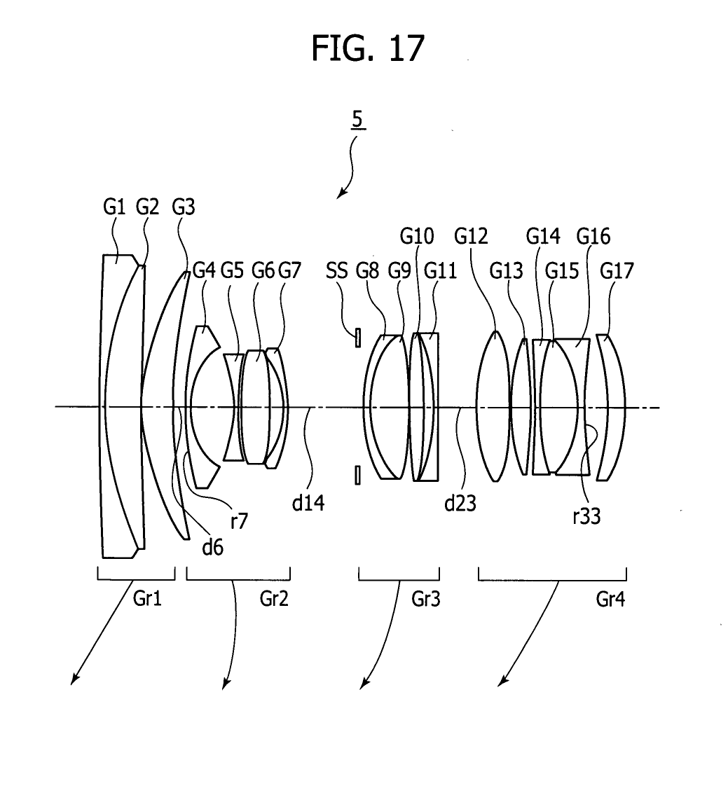

FIG. 17 shows the lens construction at the wide-angle end of a zoom lens 5 according to a fifth embodiment, indicating, with arrows, motion loci of its constituent lens groups along the optical axis toward the telephoto end, respectively.

The zoom lens 5 includes, in the following order from the object side, a first lens group Gr1 having positive refractive power, a second lens group Gr2 having negative refractive power, a third lens group Gr3 having positive refractive power, and a fourth lens group Gr4 having positive refractive power. During zooming from the wide-angle end to the telephoto end, the first to fourth lens groups move toward the object side as indicated by the arrows, respectively, in FIG. 17 such that a distance between the first lens group Gr1 and the second lens group Gr2 increases, a distance between the second lens group Gr2 and the third lens group Gr3 decreases, and a distance between the third lens group Gr3 and the fourth lens group Gr4 decreases. Further, the second lens group Gr2 moves along the optical axis to perform focusing.

The first lens group Gr1 includes, in the following order from the object side, a cemented positive lens made of a negative meniscus lens G1 and a positive meniscus lens G2, each having a convex surface facing the object side, and a positive meniscus lens G3 having a convex surface facing the object side. The second lens group Gr2 includes, in the following order from the object side, a negative meniscus lens G4 having a convex surface facing the object side and having the object-side surface formed of an aspherical surface, a biconcave negative lens G5, a biconvex positive lens G6, and a negative meniscus lens G7 having a convex surface facing the image side. The third lens group Gr3 includes, in the following order from the object side, a cemented positive lens made of a negative meniscus lens G8 having a convex surface facing the object side and a biconvex positive lens G9, a biconvex positive lens G10, and a negative meniscus lens G11 having a convex surface facing the image side. The fourth lens group Gr4 includes, in the following order from the object side, a biconvex positive lens G12, a biconvex positive lens G13, a cemented-triplet negative lens, and a positive meniscus lens G17 having a convex surface facing the image side. The cemented-triplet negative lens block includes, in the following order from the object side, a biconcave negative lens G14, a biconvex positive lens G15, and a biconcave negative lens G16 having an image-side surface formed of an aspherical surface. Further, an aperture stop SS is arranged in proximity to the object side of the third lens group Gr3. The aperture stop SS moves together with the third lens group Gr3.

Table 13 shows lens data of a fifth numerical embodiment in which specific numerical values are applied to the zoom lens 5 according to the fifth embodiment.

TABLE 13

| | AXIAL | | |
|---|---|---|---|
| RADIUS OF | SURFACE | REFRACTIVE | ABBE |
| CURVATURE | DISTANCE | INDEX | NUMBER |
| r1 = 504.081 | d1 = 1.800 | N1 = 1.84666 | ν1 = 23.78 |
| r2 = 71.854 | d2 = 0.010 | N2 = 1.51400 | ν2 = 42.83 |
| r3 = 71.854 | d3 = 7.700 | N3 = 1.83481 | ν3 = 42.72 |
| r4 = 584.881 | d4 = 0.150 | | |
| r5 = 50.971 | d5 = 6.500 | N4 = 1.83481 | ν4 = 42.72 |
| r6 = 117.843 | d6 = variable | | |
| r7 = 98.067 | d7 = 1.250 | N5 = 1.77250 | ν5 = 49.36 |
| r8 = 16.107 | d8 = 9.330 | | |
| r9 = −30.479 | d9 = 1.000 | N6 = 1.80420 | ν6 = 46.50 |
| r10 = 73.121 | d10 = 0.290 | | |
| r11 = 49.985 | d11 = 6.960 | N7 = 1.84666 | ν7 = 23.78 |
| r12 = −43.586 | d12 = 2.660 | | |
| r13 = −19.820 | d13 = 1.000 | N8 = 1.77250 | ν8 = 49.62 |
| r14 = −34.419 | d14 = variable | | |
| r15 = aperture stop | d15 = 1.700 | | |
| r16 = 44.559 | d16 = 1.000 | N9 = 1.88300 | ν9 = 40.80 |
| r17 = 22.781 | d17 = 0.010 | N10 = 1.51400 | ν10 = 42.83 |
| r18 = 22.781 | d18 = 8.540 | N11 = 1.72000 | ν11 = 50.34 |
| r19 = −90.909 | d19 = 0.150 | | |
| r20 = 141.075 | d20 = 3.060 | N12 = 1.83481 | ν12 = 42.72 |
| r21 = −154.416 | d21 = 2.020 | | |
| r22 = −46.164 | d22 = 1.100 | N13 = 1.90366 | ν13 = 31.32 |
| r23 = −191.269 | d23 = variable | | |
| r24 = 36.148 | d24 = 7.700 | N14 = 1.49700 | ν14 = 81.61 |
| r25 = −52.812 | d25 = 0.250 | | |
| r26 = 66.234 | d26 = 4.200 | N15 = 1.49700 | ν15 = 81.61 |
| r27 = −84.106 | d27 = 0.760 | | |
| r28 = −100.000 | d28 = 0.950 | N16 = 1.90366 | ν16 = 31.32 |
| r29 = 73.539 | d29 = 0.010 | N17 = 1.51400 | ν17 = 42.83 |
| r30 = 73.539 | d30 = 8.100 | N18 = 1.48749 | ν18 = 70.44 |
| r31 = −23.330 | d31 = 0.010 | N19 = 1.51400 | ν19 = 42.83 |
| r32 = −23.330 | d32 = 1.450 | N20 = 1.77250 | ν20 = 49.36 |
| r33 = 296.121 | d33 = 5.000 | | |
| r34 = −61.290 | d34 = 3.880 | N21 = 1.83400 | ν21 = 37.34 |
| r35 = −32.148 | | | |

In Table 13, N2, ν2, N10, ν10, N17, ν17, N19, and ν19 denote the refractive indexes and the Abbe numbers of cementing materials in the cemented lenses. Further, the negative meniscus lens G11 closest to the image side of the third lens group Gr3, and the biconcave lens G14 on the object side of the cemented triplet in the fourth lens group Gr4 are formed of glass members having refractive indexes of not less than 1.9, respectively.

The distance d6 between the first lens group Gr1 and the second lens group Gr2, the distance d14 between the second lens group Gr2 and the aperture stop SS, and the distance d23 between the third lens group Gr3 and the fourth lens group Gr4 vary during zooming from the wide-angle end to the telephoto end. The values of the distances d6, d14, and d23 in the fifth embodiment measured at a wide-angle end (f=24.70), at an intermediate focal length (f=37.98) between the wide-angle end and a telephoto end, and at the telephoto end (f=67.95) are shown in Table 14 along with focal lengths f, F-numbers FNO, and angles of view 2ω.

TABLE 14

| | | | |
|---|---|---|---|
| f | 24.70 | 37.98 | 67.95 |
| FNO | 2.88 | 2.88 | 2.90 |
| 2ω | 83.8 | 59.1 | 34.7 |
| d6 | 2.778 | 12.920 | 27.688 |
| d14 | 15.202 | 7.708 | 1.000 |
| d23 | 8.124 | 3.250 | 0.500 |

A surface closest to the object side of the second lens group Gr2, i.e., an object-side surface r7 of the negative meniscus lens G4, and an image-side surface r33 of the cemented-triplet negative lens of the fourth lens group Gr4, i.e., the image-side surface of the biconcave negative lens G16, are formed of aspherical surfaces. Aspherical coefficients of the above-mentioned surfaces in the fifth numerical embodiment are shown in Table 15 along with cone constants ε.

TABLE 15
ASPHERICAL COEFFICIENTS

r7
ε = 1.0000
A4 = 0.12736009 × 10⁻⁴
A6 = −0.67365016 × 10⁻⁸
A8 = −0.71808301 × 10⁻¹⁰
A10 = 0.78825874 × 10⁻¹²
A12 = −0.26948768 × 10⁻¹⁴
A14 = 0.37189316 × 10⁻¹⁷
r33
ε = 1.0000
A4 = 0.17495023 × 10⁻⁴
A6 = 0.38801483 × 10⁻⁸
A8 = −0.11234198 × 10⁻⁹
A10 = 0.10535738 × 10⁻¹¹
A12 = −0.46012946 × 10⁻¹⁴
A14 = 0.73037374 × 10⁻¹⁷

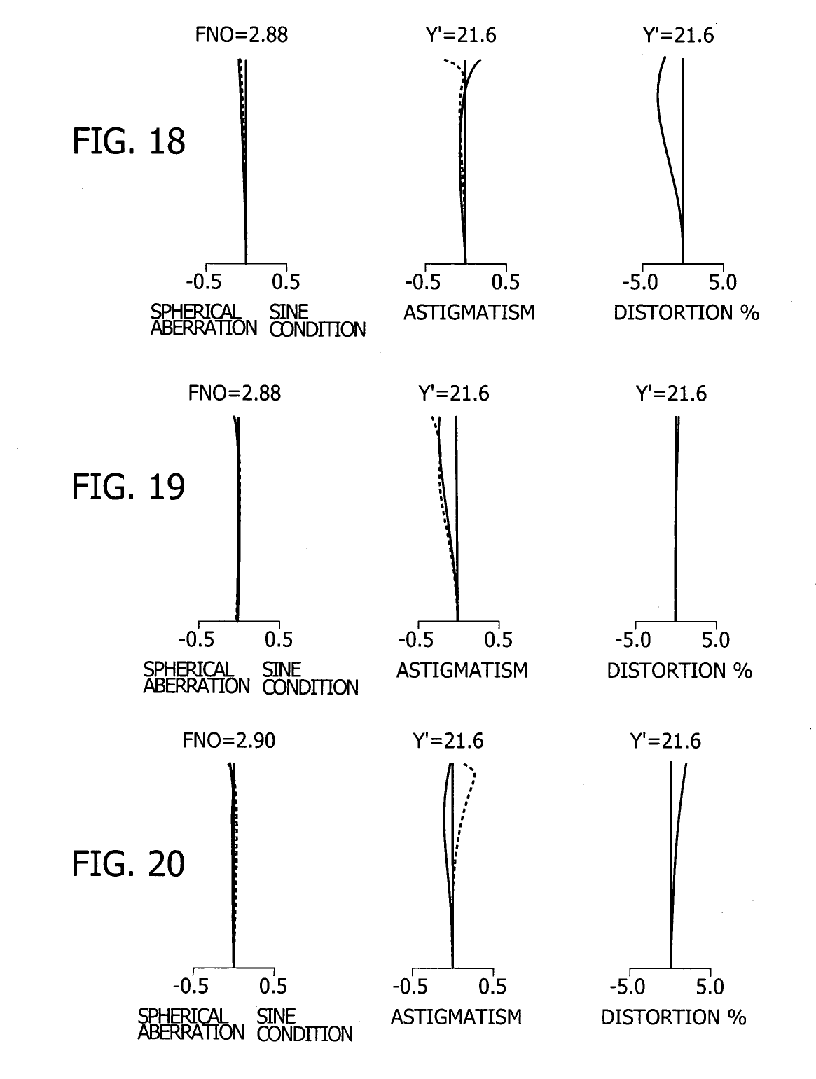

Each of FIGS. 18 to 20 shows a spherical aberration, an astigmatism, and a distortion in the fifth embodiment which is in focus at infinity. FIG. 18 shows the aberrations measured at the wide-angle end. FIG. 19 shows the aberrations measured at the intermediate focal length. FIG. 20 shows the aberrations measured at the telephoto end. In each of the spherical-aberration graphs, a solid line represents a spherical aberration at d-line and a dashed line represents a sine condition. In each of the astigmatism graphs, a solid line represents a sagittal image plane and a dashed line represents a meridional image plane.

The following Table 16 shows numerical values for obtaining conditions of the conditional formulae (1) to (5) of the zoom lenses disclosed in the first to fifth numeral embodiments, as well as the respective conditional formulae, provided that a description in the “conditional formula” section for the conditional formula (5) is omitted.

TABLE 16

| | | NUMERICAL | NUMERICAL | NUMERICAL | NUMERICAL | NUMERICAL |
|---|---|---|---|---|---|---|
| CONDITIONAL | | EMBODIMENT | EMBODIMENT | EMBODIMENT | EMBODIMENT | EMBODIMENT |
| FORMULA | | 1 | 2 | 3 | 4 | 5 |
| (1) | f3/fw | 2.09 | 2.08 | 2.20 | 2.28 | 2.24 |
| (2) | D3/f2 | −0.67 | −0.73 | −0.63 | −0.66 | −0.65 |
| (3) | f2/fw | −1.87 | −1.63 | −1.95 | −1.83 | −1.83 |
| (4) | β2w/β2t | 1.49 | 1.46 | 1.55 | 1.51 | 1.51 |
| (5) | Omitted | 5.44 | 4.70 | 17.77 | 7.79 | 8.04 |

As is apparent from Table 16 shown above, the zoom lenses according to the first to fifth numeral embodiments satisfy the conditional formulae (1) to (5). Further, as shown in the aberration graphs, their aberrations are corrected with good balance at the wide-angle end, the intermediate focal length between the wide-angle end and the telephoto end, and the telephoto end.

An image capture apparatus according to an embodiment of the present invention will be described next.

The image capture apparatus includes a zoom lens, and an image sensor for converting an optical image formed by the zoom lens into an electrical signal. The zoom lens includes, in the following order from the object side, a first lens group having positive refractive power, a second lens group having negative refractive power, a third lens group having positive refractive power, and a fourth lens group having positive refractive power. During power variation from a wide-angle end to a telephoto end, the first lens group, the third lens group, and the fourth lens group move toward the object side such that a distance between the first lens group and the second lens group increases, a distance between the second lens group and the third lens group decreases, and a distance between the third lens group and the fourth lens group decreases. The zoom lens satisfies the following conditional formulae (1) and (2):

1.8<f3/fw<5 (1)

−2.5<2×D3/f2<−1.5, (2)

where:
f3 represents a composite focal length of the third lens group,
fw represents a composite focal length of the total system at the wide-angle end,
D3 represents a height from the optical axis of axial rays passing through a surface closest to the object side of the third lens group at the telephoto end, and
F2 represents a composite focal length of the second lens group.

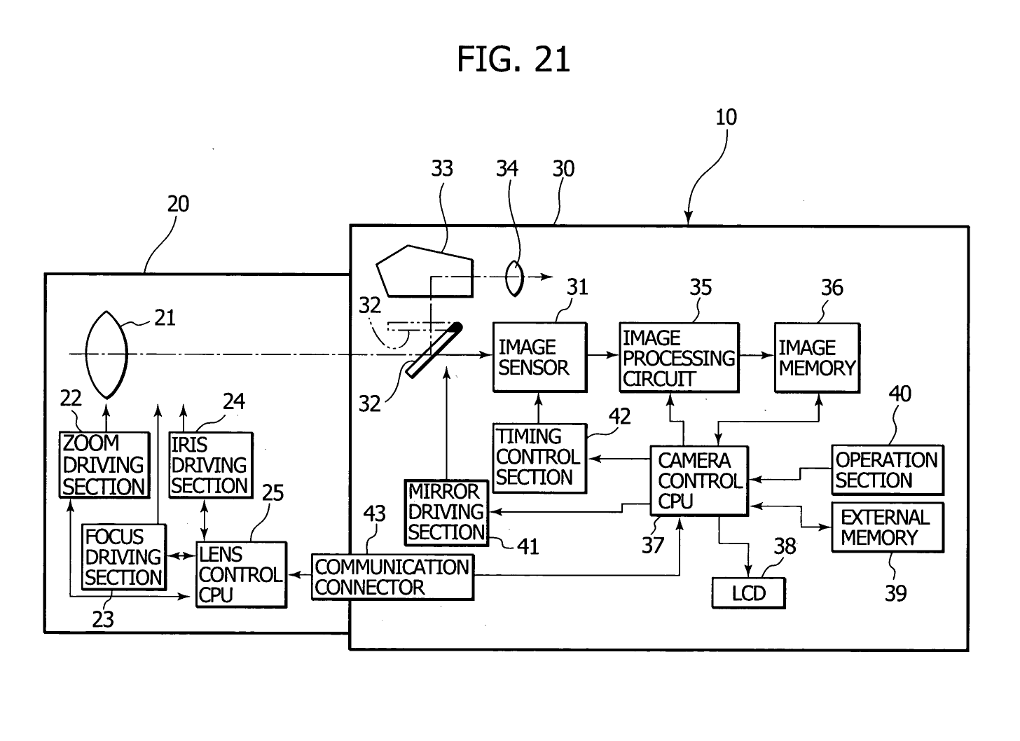

FIG. 21 is a block diagram of a digital camera according to an embodiment of the image capture apparatus of the present invention.

A digital camera 10 is constructed as a so-called single-lens reflex camera of an interchangeable lens type. The digital camera 10 is designed for use such that a lens unit 20 is releasably attached to a camera body 30 having an image sensor.

The lens unit 20 includes a driving section and a control section. The driving section drives a zoom lens or a single-focus lens, and various parts of the lens. The control section drives and controls the driving section. The lens unit 20 can use any of the above-described zoom lenses as the lens. Namely, the lens unit 20 can use any of the above-described zoom lenses according to the zoom lenses 1 to 5 disclosed in the above-described embodiments and their numerical embodiments, or according to any embodiment other than the above-described embodiments and numeral embodiments. When the above-mentioned lens is a zoom lens 21, the lens unit 20 includes various driving sections, such as a zoom driving section 22 for moving predetermined lens groups during zooming, a focus driving section 23 for moving predetermined lens groups during focusing, and an iris driving section 24 for changing the diameter of the aperture stop. The lens unit 20 further includes a lens control CPU (Central Processing Unit) 25 for driving these driving sections.

The camera body 30 includes an image sensor 31 for converting an optical image formed by the zoom lens 21 into an electrical signal. Also, a jump-up mirror 32 is arranged in front of the image sensor 31 to guide light from the zoom lens 21 to a pentaprism 33, and further from the pentaprism 33 to an eyepiece, or ocular lens, 34. Thus, a photographer can view the optical image formed by the zoom lens 21 through the eyepiece 34.

As the image sensor 31, a CCD (Charge Coupled Device) or a CMOS (Complementary Metal-Oxide Semiconductor) may be applicable, for example. The electrical image signal outputted from the image sensor 31 is subjected to various processing at an image processing circuit 35, then data-compressed with a predetermined method, and temporarily stored in an image memory 36 as image data.

A camera control CPU (Central Processing Unit) 37 centrally controls both the camera body 30 and the lens unit 20 as a whole. The CPU 37 extracts the image data temporarily stored in the image memory 36 for display on a liquid crystal display device 38 or for storage in an external memory 39. Also, the camera control CPU 37 reads out image data stored in the external memory 39 for display on the liquid crystal display device 38. Signals from an operation section 40 including a shutter release switch and a zooming switch are supplied to the camera control CPU 37, and the CPU 37 controls various parts responsive to these signals from the operation section 40. For example, when the shutter release switch is operated, the camera control CPU 37 gives one command to a mirror driving section 41 and another command to a timing control section 42. Then, the mirror driving section 41 causes the jump-up mirror 32 to jump up as shown by dot-dot-dashed lines in the figure, to allow entrance of light rays from the zoom lens 21 to the image sensor 31, and the timing control section 42 controls signal read timing at the imager device. The camera body 30 and the lens unit 20 are interconnected via a communication connector 43. Signals related to control of the zoom lens 21, e.g., an AF (Auto Focus) signal, an AE (Auto Exposure) signal, and a zooming signal, are delivered to the lens control CPU 25 via the communication connector 43 from the camera control CPU 37, and then the lens control CPU 25 controls the zoom driving section 21, the focus driving section 23, and the iris driving section 24 to set the zoom lens 21 to a predetermined state.

In the above-mentioned embodiments of the present invention, it is possible to achieve high performance and compactness, and also ensure back focus sufficiently.

While the image capture apparatus has been disclosed as a single-lens reflex camera in the above embodiment, the apparatus may be applied as a fixed-lens camera. Alternatively, the image capture apparatus may be applied not only as a digital camera, but as a silver-salt-film camera as well.

In addition, the shapes of the respective sections as well as the numerical values that have been referred to in the above description of the embodiments are provided merely as one example for illustrative purposes for ease of understanding of various embodiments for carrying out the present invention, and these embodiments are not to be construed as limiting the technical scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising, in an order from an object side:
a first lens group having positive refractive power;
a second lens group having negative refractive power;
a third lens group having positive refractive power; and
a fourth lens group having positive refractive power, and wherein:
during zooming from a wide-angle end to a telephoto end, the first lens group, the third lens group, and the fourth lens group move toward an object side such that a distance between the first lens group and the second lens group increases, a distance between the second lens group and the third lens group decreases, and a distance between the third lens group and the fourth lens group decreases, and
the zoom lens satisfies the following conditional formulae (1) and (2):
1.8<f3/fw<5, and (1)
−2.5<2×D3/f2<−1.5, (2)
where:
f3 represents a composite focal length of the third lens group,
fw represents a composite focal length of a total system at a wide-angle end,
D3 represents a height from an optical axis of axial rays passing through a surface closest to the object side of the third lens group at a telephoto end, and
f2 represents a composite focal length of the second lens group.

2. The zoom lens according to claim 1, wherein the following conditional formula (3) is satisfied:
0.8<f2/fw<−0.2. (3)

3. The zoom lens according to claim 1, wherein the following conditional formula (4) is satisfied:
1.2<β2w/β2t<1.7, (4)
where:
β2w represents a transverse magnification at the wide-angle end, and
β2t represents a transverse magnification at the telephoto end.

4. The zoom lens according to claim 1, comprising at least one lens using a glass member whose refractive index is not less than 1.9, in any of the third lens group and the fourth lens group.

5. The zoom lens according to claim 1, wherein focusing is performed by moving the second lens group along the optical axis.

6. The zoom lens according to claim 1, comprising at least one aspherical surface within the second lens group.

7. An image capture apparatus comprising a zoom lens and an image sensor for converting an optical image formed by the zoom lens into an electrical signal, wherein:
the zoom lens includes, in an order from an object side:
a first lens group having positive refractive power;
a second lens group having negative refractive power;
a third lens group having positive refractive power; and
a fourth lens group having positive refractive power,
during zooming from a wide-angle end to a telephoto end, the first lens group, the third lens group, and the fourth lens group move toward an object side such that a distance between the first lens group and the second lens group increases, a distance between the second lens group and the third lens group decreases, and a distance between the third lens group and the fourth lens group decreases, and
the zoom lens satisfies the following conditional formulae (1) and (2):
1.8<f3/fw<5, and (1)
−2.5<2×D3/f2<−1.5, (2)
where:
f3 represents a composite focal length of the third lens group,
fw represents a composite focal length of a total system at a wide-angle end,
D3 represents a height from an optical axis of axial rays passing through a surface closest to the object side of the third lens group at a telephoto end, and
f2 represents a composite focal length of the second lens group.
